(19) United States
(12) Patent Application Publication
(10) Pub. No.: US 2022/0214238 A1
(43) Pub. Date: Jul. 7, 2022

(54) DEVICES AND METHODS FOR MONITORING HEALTH AND PERFORMANCE OF A MECHANICAL SYSTEM

(71) Applicants: MASSACHUSETTS INSTITUTE OF TECHNOLOGY, Cambridge, MA (US); THE JAPAN STEEL WORKS, LTD., Tokyo (JP)

(72) Inventors: Erik GEST, Mercer Island, WA (US); Mikio FUROKAWA, Taisho-machi (JP); Takayuki HIRANO, Kashiwa-shi (JP); Kamal YOUCEF-TOUMI, Cambridge, MA (US)

(21) Appl. No.: 17/610,984

(22) PCT Filed: May 16, 2020
(86) PCT No.: PCT/US2020/033319

§ 371 Date: Nov. 12, 2021

Related U.S. Application Data
(60) Provisional application No. 62/849,835, filed on May 17, 2019.

(51) Int. Cl. G01L 3/10; G01L 1/22

(52) U.S. Cl. CPC G01L 3/108; G01L 1/2225

(57) ABSTRACT

Systems, devices, and methods for monitoring the health of a mechanical system that includes a rotating shaft as disclosed can measure various parameters of the rotating shaft to assess health and performance of the mechanical system. A measuring device can rotate with the rotating shaft and can allow for strain to be measured in tension, which can provide for accurate rotating shaft parameter measurements with low cost and simple installation. The measuring device can include a connector that can couple to the rotating shaft, a bridge that can couple to the connector, and a strain-measuring sensor associated with the bridge such that the strain sensor can measure deformation of a portion of the bridge that can deform with rotation of the rotating shaft. The measuring device can be designed to amplify the strain experienced by the rotating shaft which can reduce noise in the strain measurement.

### CROSS REFERENCE TO RELATED APPLICATIONS

The present application claims priority to and the benefit of U.S. Provisional Application No. 62/849,835, filed May 17, 2019, and titled “Devices and Methods for Monitoring Health and Performance of a Mechanical System,” the contents of which is incorporated herein by reference in its entirety.

### FIELD

The present disclosure relates to devices and methods for monitoring the health and performance of a mechanical system, and more particularly relates to devices for measuring strain that can be coupled to or otherwise associated with a rotating shaft of a mechanical system to assist in monitoring the health and performance of the mechanical system.

### BACKGROUND

Health monitoring and prediction of mechanical systems can aid in avoidance of system failures, alerting a user of a needed repair, estimating and minimizing wear, and/or increasing safety of the system by preventing dangerous operating conditions before they happen. In many mechanical systems, e.g., in the field of transportation, power generation, industrial equipment, robotics, etc., one or more rotating shafts can be a main means of mechanical power transmission. As such, measuring properties of the rotating shaft(s), e.g., torque, speed, vibration, bending, etc., can be used in many cases to assess system performance and health and, in some instances, implement system controls. Many issues such as long-term fatigue, wear related issues, and acute failures can cause symptoms in the system that can be detectable on the shaft. Accordingly, if each of torque, speed, vibration, and bending can be measured, it is likely that problems with the system can be detected before they become critical, which can reduce damage and increase both system performance and safety.

Known torque sensors for rotating shafts commonly have their own axle that can require connection to the rotating shaft on both ends. This can require cutting or otherwise altering the shaft for the torque sensor to be installed, which can make the installation process long and can increase a chance of damage to the system. Moreover, if a particular rotating shaft or system was not designed for a particular torque sensor, the sensor may be incompatible with the system, e.g., the shaft may not have a long enough exposed portion for the sensor to be added.

Clamp-on surface acoustic wave (SAW) sensors and clamp-on optical sensors are other known sensors that can be used for measuring torque of a rotating shaft. While these sensors can be installed without modification to the shaft, they can require careful mounting of components on a surface of the shaft and can thus result in a long installation process that can require a high level of precision. Additionally, the rotating shaft is often narrowed in a section where measurements are taken with a clamp-on SAW or optical sensor, which can further complicate the installation process, weaken the shaft, and/or damage the shaft in a manner that prevents the sensor from staying clamped on the shaft for a desired, extended period of time.

As with torque, solutions exist that can measure the speed of a rotating shaft. For example, magnets, encoders, photo tachometers, and motors can be used to measure speed of a rotating shaft. Each of these, however, can require that part of the sensor or device remain stationary or fixed in a non-rotating reference frame. In some cases, it can be advantageous to have no parts fixed to the stationary reference frame.

Accordingly, there is a need in the art for a measuring device that can accurately detect one or more parameters of a rotating shaft such that health of a mechanical system associated with the shaft can be determined in a manner that can be low cost, involve a simple installation, and does not require any component of the measuring device to remain in a stationary reference frame.

### SUMMARY

The present application is directed to devices and methods that can measure various parameters of a rotating shaft of a mechanical system. Measuring these parameters can allow for the health and performance of the rotating shaft, and the mechanical system more generally, to be monitored. The provided for devices and methods can allow strain to be measured in tension, as opposed to shear. As a result, a variety of different strain-measuring sensors can be used, including cheaper and more common tensile strain gauges.

The design of exemplary devices provided for herein is such that they can mechanically amplify the actual strain being experienced by a rotating shaft of a mechanical system when the system is being operated. More particularly, the device can be coupled to the rotating shaft in a manner such that the device can rotate with the shaft. In exemplary embodiments disclosed, all parts of such devices can move, i.e., are not fixed in any way, relative to a stationary reference frame. This can allow for a simple installation of the device on the rotating shaft. The design can also allow the device to be built with relatively low tolerances while retaining accuracy in measurement. Still further, in addition to being able to measure tension, the devices and methods provided for herein can also allow for the measurement of torque (also described as twisting, and includes both torque transmitted through the shaft and the torsion of the shaft), speed, acceleration (by virtue of being able to measure speed), vibrations, and bending-all without the device being fixed in any way to a stationary reference frame. Accordingly, the provided for devices and methods can allow for the measurement of these various parameters in a simple and accessible manner without having to modify the shaft in any way.

In one exemplary embodiment of a device for monitoring a mechanical system that includes a rotating shaft, the device includes a connector, a bridge coupled to the connector, and a strain-measuring sensor associated with the bridge (e.g., disposed on, disposed within, etc.). The connector is configured to couple to a rotating shaft, with the connector having a first reference location and a second reference location. The bridge extends between the first and second reference locations and is configured to be disposed such that a longitudinal axis thereof is laterally offset from a central longitudinal axis of the rotating shaft when the connector is coupled to a rotating shaft. The longitudinal axis and the central longitudinal axis are substantially parallel to each other, and the bridge includes a flexure zone configured to deform in response to the rotating shaft undergoing a torsional force during operation of the rotating shaft. The strain-measuring sensor is disposed between the first and second reference locations and is configured to determine a magnitude of the torsional force experienced by the rotating shaft during operation of the rotating shaft based on a strain measured by the strain-measuring sensor.

Each of the connector, the bridge, and the strain-measuring sensor can be configured to rotate with the rotating shaft such that strain is measured by the strain-measuring sensor without a stationary reference frame. In some embodiments, each and every component of device for monitoring a mechanical system that includes a rotating shaft rotates with the rotating shaft.

The strain-measuring sensor can be configured to detect bending of the rotating shaft during operation of the rotating shaft. This is in addition to the sensor measuring the strain. In some embodiments, the device can also include an accelerometer. The accelerometer can be configured to determine a rotational speed of the rotating shaft during operation of the rotating shaft. This is in addition to the sensor measuring the strain, and can, but does not have to, be in addition to the sensor detecting bending. In some embodiments, the accelerometer can also be configured to detect a frequency of vibrations present on the rotating shaft during operation of the rotating shaft and/or an amplitude of vibrations present on the rotating shaft during operation of the rotating shaft. This is in addition to the sensor measuring the strain, and can, but does not have to, be in addition to the sensor detecting bending and/or the accelerometer determining a rotational speed of the rotating shaft during operation of the rotating shaft.

The strain-measuring sensor can be configured to measure strain in tension. In some embodiments, the strain-measuring sensor can include a tensile strain gauge. In some embodiments, the strain-measuring sensor can include two mechanical bridges disposed in a half Wheatstone bridge configuration. Alternatively, the strain-measuring sensor can include four mechanical bridges disposed in a full Wheatstone bridge configuration.

The strain measured by the strain-measuring sensor can be greater than a strain experienced by the rotating shaft when it is undergoing the torsional force. In at least some such embodiments, the bridge can be configured such that a distance of the lateral offset between the longitudinal axis of the bridge and the central longitudinal axis of the rotating shaft is adjustable to in turn adjust the difference between the strain measured by the strain-measuring sensor and the strain experienced by the rotating shaft when it is undergoing the torsional force.

The bridge can include a first abutment, a second abutment, and a span. The first abutment can be coupled to the connector more proximate to the first reference location than the second reference location, and the second abutment can be coupled to the connector more proximate to the second reference location than the first reference location. The span can extend between the first and second abutments, with the strain-measuring sensor being associated with the span (e.g., disposed on, disposed within, etc.). In some embodiments, the connector can include a first collar and a second collar, with the first collar including the first reference location and the second collar including the second reference location. The first abutment can be coupled to the first collar and the second abutment can be coupled to the second collar. In at least some embodiments, the bridge can have a modulus of rigidity that is less than the modulus of rigidity of the rotating shaft. By way of non-limiting example, in some embodiments the bridge can have a modulus of rigidity that is at least five times less than a modulus of rigidity of the rotating shaft. This can be alternatively described as the bridge including a material (or combination of materials) having a modulus of rigidity that is at least five times less than a material (or combination of materials) from which the rotating shaft is formed. Alternative ratios of the modulus of rigidity of the bridge (or material(s) used to form the bridge) as compared to the modulus of rigidity of the rotating shaft (or material(s) use to form the rotating shaft) include but are not limited to 1:2, 1:4, 1:10, 1:20, 1:25, 1:50, and 1:100.

One exemplary embodiment of a method for monitoring a mechanical system that includes a rotating shaft includes measuring a mechanically amplified strain of a rotating shaft of a mechanical system using a strain-measuring device coupled to the rotating shaft of the mechanical system. This action is performed such that the strain-measuring device rotates with the rotating shaft when the rotating shaft is being operated. The measured mechanically amplified strain is greater than a strain experienced by the rotating shaft when it is being operated.

Each and every component of the strain-measuring device configured to be coupled to the rotating shaft and/or measure a strain associated with the rotating shaft can rotate with the rotating shaft when the rotating shaft is being operated. Each and every component of the strain-measuring device configured to be coupled to the rotating shaft and/or measure a strain associated with rotating shaft can include: (1) a connector coupled to the rotating shaft; (2) a bridge coupled to the connector; and (3) a strain-measuring sensor associated with (e.g., disposed on, disposed within, etc.), with the sensor performing the action of measuring the mechanically amplified strain of the rotating shaft. In some such embodiments, when the bridge can be disposed such that a longitudinal axis of the bridge is laterally offset from a central longitudinal axis of the rotating shaft, with the longitudinal axis and the central longitudinal axis being substantially parallel to each other.

The method can also include coupling the strain-measuring device to the rotating shaft. For example, that can include coupling a first collar of the strain-measuring device to a first location on the rotating shaft, and coupling a second collar of the strain-measuring device to a second location on the rotating shaft. In such embodiments, the strain-measuring device can include a bridge that extends between the two collars. A longitudinal axis of the bridge can be laterally offset from a central longitudinal axis of the rotating shaft, with the longitudinal axis and the central longitudinal axis being substantially parallel to each other. In some such embodiments, the method can further include adjusting a distance of the lateral offset between the longitudinal axis of the bridge and the central longitudinal axis of the rotating shaft to adjust a value of the mechanically amplified strain with respect to the strain experienced by the rotating shaft when it is being operated.

The strain-measuring device can measure the mechanically amplified strain of the rotating shaft of the mechanical system in tension. In some embodiments, the strain-measuring device can include a strain-measuring sensor. The strain-measuring sensor can be disposed a distance away from the rotating shaft such that the strain-measuring sensor does not directly contact the rotating shaft and is laterally offset from a central longitudinal axis of the rotating shaft.

In some embodiments, the method can include detecting bending of the rotating shaft during operation of the rotating shaft using the strain-measuring device. This detection can be in addition to measuring the mechanically amplified strain. The method can also include determining a rotational speed of the rotating shaft during operation of the rotating shaft using the strain-measuring device. This determination can be in addition to measuring the mechanically amplified strain and/or detecting bending of the rotating shaft. Still further, the method can include detecting a frequency of vibrations present on the rotating shaft during operation of the rotating shaft and/or an amplitude of vibrations present on the rotating shaft during operation of the rotating shaft using the strain-measuring device. This detection can be in addition to any or all of measuring the mechanically amplified strain, detecting the bending of the rotating shaft, and/or determining a rotational speed of the rotating shaft.

### BRIEF DESCRIPTION OF DRAWINGS

This disclosure will be more fully understood from the following detailed description taken in conjunction with the accompanying drawings, in which:

FIG. 1 is a perspective view of one exemplary embodiment of a measuring device for monitoring a mechanical system that includes a rotating shaft;

FIG. 2 is perspective view of the measuring device of FIG. 1 coupled to a rotating shaft with a finite element analysis showing strain of the measuring device and rotating shaft during operation of the rotating shaft;

FIG. 3 illustrates three exemplary strain measuring sensors that can form part of the measuring device of FIG. 1;

FIG. 4 is a perspective view of another exemplary embodiment of a measuring device for monitoring a mechanical system that includes a rotating shaft;

FIG. 5 illustrates a test set-up of the measuring device of FIG. 4 coupled to a rotating shaft;

FIG. 6 is a graph showing torque measured by the measuring device of FIG. 5 and applied torque over time;

FIG. 7 is a graph comparing torque measured by the measuring device of FIG. 5 to applied torque;

FIG. 8 is a graph showing a strain sensor reading of the measuring device of FIG. 5 over time;

FIG. 9 illustrates a power spectrum of a strain sensor reading of the measuring device of FIG. 5 at various speeds of the rotating shaft of FIG. 5; and

FIG. 10 is a graph showing a power spectrum of acceleration data measured by the measuring device of FIG. 5.

### DETAILED DESCRIPTION

Certain exemplary embodiments will now be described to provide an overall understanding of the principles of the structure, function, manufacture, and use of the devices, systems, and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Still further, the present disclosure provides some illustrations and descriptions that includes prototypes, bench models, and or schematic illustrations of set-ups. A person skilled in the art will recognize how to rely upon the present disclosure to integrate the techniques, systems, devices, and methods provided for into a product, such as a consumer-ready, factory-ready, or lab-ready three-dimensional printer.

The present disclosure is generally directed to devices, systems, and methods for monitoring the health of a mechanical system that includes a rotating shaft by measuring one or more parameters of the rotating shaft to access system performance and health and/or to implement system controls. Devices of the present disclosure can include a connector that can couple to a rotating shaft and a bridge that can couple to the connector. The bridge can have a flexure zone that can deform in response to the rotating shaft undergoing a torsional force during operation. A strain-measuring sensor can be associated with the bridge and, more particularly, with the flexure zone, and can determine a magnitude of the torsional force experienced by the rotating shaft during operation thereof based on a strain of the flexure zone measured by the strain sensor. A strain-measuring sensor can measure the strain of the deformed portion of the bridge to determine strain on the rotating shaft. Each and every component of the measuring device can rotate with the rotating shaft. In other words, the measuring device can exist entirely within a rotating reference frame, without any component thereof being fixed in a stationary reference frame. Accordingly, a majority of the calibration and precise arrangement of sensing components can take place prior to installation of the measuring device onto the rotating shaft which can ease the installation process. Moreover, measuring devices of the present disclosure can be designed such that the devices can be compact as compared to standard torque transducers.

Measuring devices of the present disclosure can measure strain on the rotating shaft in tension, rather than in shear. This can provide for the use of cheaper and more common tensile strain gauges. The strain of the rotating shaft during operation can be mechanically amplified utilizing geometric and material properties of the measuring device. The strain sensor can transfer strain from the rotating shaft and can amplify the strain reading to increase sensitivity of the strain measurement. In many cases, the measuring device can also detect bending of the rotating shaft. The sensor(s) associated with the measuring device can be built with relatively low tolerances while retaining accuracy in measurement.

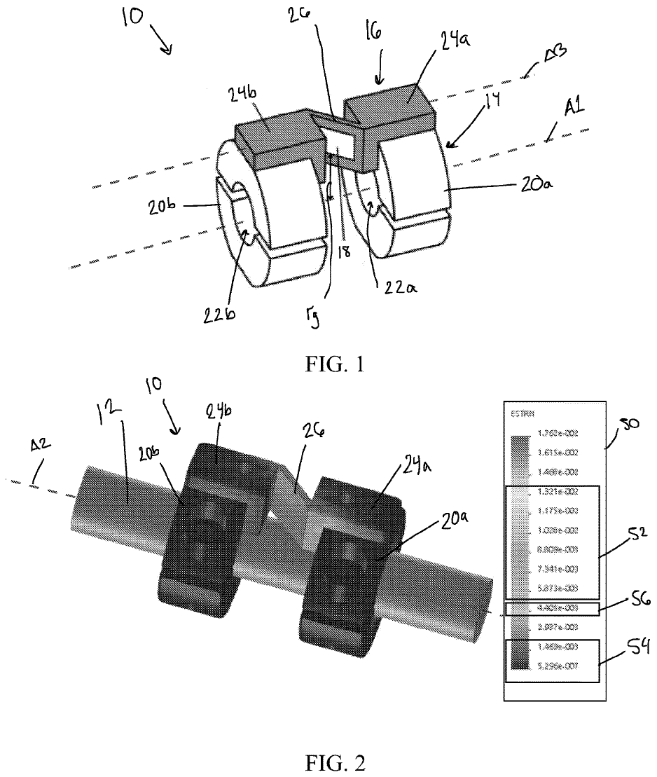

FIG. 1 shows a perspective view of one embodiment of a measuring device 10 of the present disclosure that can measure strain of a rotating shaft 12 (FIG. 2), e.g., to calculate one or more parameters of the rotating shaft, such as torque and/or bending. The rotating shaft 12 can be a component in a larger mechanical system (not shown), including, for example, a drive shaft system or a turbine shaft system. The measuring device 10 can include a connector 14 that can be coupled to the rotating shaft 12 and a bridge 16 that can couple to the connector 14. A strain-measuring sensor 18 can be associated with the bridge 16. For example, the strain sensor 18 can be disposed on or disposed within the bridge 16. The strain sensor 18 can determine a magnitude of a torsional force experienced by the rotating shaft 12 coupled to the measuring device 10 during operation of the rotating shaft. A strain reading or measurement from the strain sensor 18 can be used to determine one or more health parameters of the rotating shaft 12 and, accordingly, a mechanical system that includes the rotating shaft. As discussed in detail below, the connector 14 can include a first reference location and a second reference location. The bridge 16 can be attached to the connector 14 at the first reference location and the second reference location such that the strain sensor 18 can be disposed on a portion of the bridge between the first and second reference locations.

The connector 14 can include a first collar 20a with an opening 22a and a second collar 20b with an opening 22b. A longitudinal axis A1 of the connector 14 can extend through the openings 22a, 22b. The rotating shaft 12 can be inserted through, and received within, the openings 22a, 22b such that the rotating shaft can extend through the first collar 20a and the second collar 20b. More particularly, a central longitudinal axis A2 of the rotating shaft 12 can extend co-linearly with the longitudinal axis A1 of the connector 14. In some embodiments, the first collar 20a and the second collar 20b can be bolted to the rotating shaft 12 such that the connector 14 can be securely coupled to the rotating shaft.

While the illustrated embodiment of FIGS. 1 and 2 shows the connector 14 as two collars 20a, 20b that can be bolted to the rotating shaft 12, such a design is just one non-limiting example of components that can be used as the connector to associate a strain-measuring sensor 18 with the rotating shaft 12. More generally, the connector 14 can encompass the collars 20a, 20b and other similarly-capable components. Other terms for connectors can also be used, such as a “holding means” or a “coupling means,” such terms encompassing the many different ways by which a strain-measuring sensor 18 can be associated with the rotating shaft 12 without contacting the rotating shaft directly. One skilled in the art will appreciate a variety of different components that can be used as a connector or holding/coupling means, and thus two collars (or another number of collars) is by no ways limiting to the types of configurations disclosure or otherwise contemplated by the present disclosure. For example, in one embodiment, the connector can include one or more pins extending from the shaft 12 such that the one or more pins rotate with the shaft. The bridge 16 can be affixed to the one or more pins. In some embodiments, the connector 14 can be integrally formed with the bridge 16. Further, while reference is made herein to collars 20a, 20b that can be “bolted to” the rotating shaft 12, one skilled in the art, in view of the claims, present disclosure, and knowledge of the skilled person, will understand the connector (e.g., collars) can be coupled or otherwise associated with the rotating shaft using a variety of different techniques known to those skilled in the art, so long as the connector can rotate entirely with the rotating shaft 12 within the rotating reference frame. By way of non-limiting example, the connector can be coupled or otherwise associated with the rotating shaft through welding, physical anchoring, adhesion, magnetic attraction, molecular attraction, fixing the connector to the shaft with a screw or locking pin, etc. In other embodiments, the connector 14 can be integrally formed with the rotating shaft 12.

The bridge 16 can include a first abutment 24a, a second abutment 24b, and a span 26 that can extend between and connect the first abutment and the second abutment. As will be described in detail below, the strain sensor 18 can be associated with the span 26 such that the strain sensor can measure a deformation of the span. The bridge 16 can extend between a first reference location and a second reference location of the connector 14. For example, in some embodiments, the first reference location of the connector 14 can be on the first collar 20a and the second reference location of the connector can be on the second collar 20b. The first abutment 24a of the bridge can be coupled to the first reference location on the first collar 20a and the second abutment 24b of the bridge can be coupled to the second reference location on the second collar 20b. The span 26 can extend between the first abutment 24a and the second abutment 24b of the bridge 14 and, accordingly, between the first collar 20a and the second collar 20b of the connector. A longitudinal axis A3 of the bridge 14 can be laterally offset from, and substantially parallel to, the central longitudinal axis A2 of the rotating shaft 12 when the connector 14 is coupled to the rotating shaft. In other words, the longitudinal axis A3 of the bridge 14 can be laterally offset from, and substantially parallel to, the longitudinal axis A1 of the connector 14 that can extend through the openings 22a, 22b of the collars 20a, 20b. The longitudinal axis A3 of the bridge does not necessarily have a relative position with respect to the bridge (i.e., it does not have to be “central,” “proximate to the top,” proximate to the bottom,” etc.) but when measuring or otherwise referencing a distance between the longitudinal axis of the bridge and the central longitudinal axis A2 of the rotating shaft 12 (i.e., the lateral offset), the location of the longitudinal axis of the bridge should typically be consistent. In some embodiments, the lateral offset between the longitudinal axis A3 of the bridge 16 and the central longitudinal axis A2 of the rotating shaft 12 can be adjusted. As discussed below, adjusting the lateral offset can, in turn, adjust a difference or amplification between the strain measured by the strain sensor 18 and the strain experienced by the rotating shaft 12 when the shaft is undergoing torsional force.

At least a portion of the span 26 can deform in response to the rotating shaft 12 undergoing a torsional force during operation of the rotating shaft while the connector 14 is coupled to the rotating shaft. This portion of the span 26 can be referred to as a flexure zone. In some embodiments, the entire span 26 can be the flexure zone. The strain sensor 18 can be placed on or otherwise associated with the flexure zone of the span 26 such that the strain sensor can measure deformation of the flexure zone. The strain sensor 18 can be laterally offset from the central longitudinal axis A2 of the rotating shaft 12 by a distance r_{g}, which can be measured from the central longitudinal axis of the rotating shaft to a point on the strain sensor closest to the central longitudinal axis of the rotating shaft.

With the measuring device 10 coupled to the rotating shaft 12, as shown, for example, in FIG. 2, the entire measuring device can rotate with the rotating shaft when the rotating shaft is operated (i.e., rotated). Accordingly, the rotating shaft 12 and the measuring device 10 can rotate simultaneously about the central longitudinal axis A2 of the rotating shaft. More particularly, each of the connector 14, the bridge 16, and the strain sensor 18 can rotate together with the rotating shaft 12 without any portion thereof fixed in a stationary reference plane. As the shaft 12 undergoes torsion, the first collar 20a and the second collar 20b of the connector 14 can be angularly displaced relative to one another. As the bridge 16 can be fixedly coupled to the connector 14 at the first and second reference points, i.e., at the first and second collars 20a, 20b, the flexure zone of the bridge, i.e., the span 26, can deform with displacement of the collars relative to one another. Accordingly, as the rotating shaft 12 rotates, the flexure zone can be either stretched or compressed due to a geometry of the span 26. The strain sensor 18, mounted to the flexure zone of the bridge 16, can measure strain of the flexure zone which can subsequently be used to determine, among other things, a strain on the rotating shaft 12. In some embodiments, the strain sensor 18 can be a tensile strain gauge that can measure strain of the flexure zone in tension, rather than in shear.

The measuring device 10 can be designed such that the strain sensor 18 can take an amplified strain measurement as compared to the actual strain experienced at a surface of the rotating shaft 12. Amplifying the strain measurement can aid in reducing sensor noise, which can be a result of electro-magnetic interference, as well as thermal effects, on a sensor. Mounting the strain sensor 18 on the bridge 16, as opposed to the rotating shaft 12, can result in the strain sensor reading a higher strain than a surface of the shaft is experiencing. Moreover, the bridge 16 can be constructed such that displacement between the collars 20a, 20b can be concentrated in the flexure zone of the span 26. Accordingly, mounting the strain sensor 18 on the flexure zone can allow for further mechanical amplification.

Sensor Methodology and Design

The strain experienced by the strain sensor 18 can be greater than that of a surface of the shaft 12 as the sensor mounted on the bridge 16 is further from an axis of rotation, i.e., the central longitudinal axis A2 of the shaft. As shown in Equation 1, below, a shear stress τ on the shaft 12 with a polar moment of inertia J and a diameter Dₛ, is proportional to the distance from the axis of rotation r and the applied torque T. For small displacements in the elastic regime, a strain on the surface of the rotating shaft ϵₛ can be determined as shown in Equation (2), where G is the shear modulus of the shaft material. As strain is proportional to stress, the strain reading on the strain sensor 18, ϵ_{g}, mounted above the shaft 12 at the distance of r_{g} from the axis of rotation A2, will be greater than a strain sensor mounted directly on the shaft. This gain is proportional to the distance r_{g} from the axis of rotation A2 divided by the diameter Dₛ of the rotating shaft 12 as shown in Equation (3).

$$\begin{matrix}τ = \frac{Tr}{J} & ( 1 ) \\ {𝔈}_{s} = \frac{8 T}{π {D}_{s}^{3} G} & ( 2 ) \\ {𝔈}_{g} = \frac{16 {Tr}_{g}}{π {D}_{s}^{4} G} & ( 3 )\end{matrix}$$

On small rotating shafts, the gain can be significant, but on larger shafts, the gain can diminish. In instances in which there is a large amount of open space around the shaft 12, it can be advantageous to increase an offset of the strain sensor 18 from the central longitudinal axis A2 of the shaft, i.e., the distance r_{g} such that amplification of the strain measured by the strain sensor can be increased. In most cases, however, a size of the strain sensor 18 and placement of the sensor relative to the shaft 12 will be limited by clearances surrounding the shaft 12 within the associated mechanical system.

The gain on the strain reading of the strain sensor 18 mounted above the shaft 12 (Equation 3) as compared to a strain sensor mounted on the shaft (Equation 2) can be further increased by a design and construction of the bridge 16. More particularly, the bridge 16 can concentrate displacement of first and second collars 20a, 20b relative to one another, which can provide for a stronger strain signal reading by the strain sensor 18 mounted onto the bridge. A cross-section of the bridge 16 and/or a material composition of the bridge can be used to isolate strain to a location onto which the strain sensor 18 can be mounted. For example, the bridge 16 can be made of a material that can have a lower modulus of rigidity than a material of the connector 14 and the rotating shaft 12. It can be beneficial to have the modulus of rigidity of the bridge 16 be less than that of the connector 14 and the rotating shaft 12 such that the bridge 16 can amplify a strain experienced by the connector and the rotating shaft when a torsional force is applied to the shaft. This can alternatively be described as the bridge 16 including a material (or a combination of materials) having a modulus of rigidity that is less than a material (or a combination of materials) from which the rotating shaft 12 or connector 14 is formed.

By way of non-limiting example, the bridge 16 can be made of a thermoplastic polymer, such as Acrylonitrile butadiene styrene (ABS) plastic, and the connector 14 can be made of aluminum. As the modulus of rigidity of aluminum is over 25 times higher than that of ABS plastic, a cross-section of the bridge 16 can experience strains approximately 25 times higher than an equivalently shaped cross-section of the connector 14. In other words, a ratio of the modulus of rigidity of the bridge 16 to the connector 14 can be a ratio of about 1:25. Other ratios, such as 1:2, 1:5, 1:10, 1:20, 1:50, 1:100, etc. are also possible. In this manner, the bridge 16 can be less rigid, by selection of bridge shape and/or material, than the connector 14 such that a majority of deformation resulting from rotation of the shaft 12 can occur in the bridge. Accordingly, deformation of the rotating shaft 12 can be amplified in deformation of the bridge 16 when the rotating shaft is in operation and undergoing a torsional force. The modulus of rigidity of the bridge 16 can also be lower than a modulus of rigidity of the rotating shaft 12. In some instances, the modulus of rigidity of the bridge 16 and the rotating shaft 12 can be nearly identical (e.g., 1:1), or the rotating shaft could have a lower modulus of rigidity, although in such instances the benefits of having a higher modulus of rigidity for the bridge would not exist. As the bridge 16 can be relatively flexible, torsional stiffness of the shaft 12 can be independent of a stiffness of the connector 14 and the bridge.

FIG. 2 shows a finite element analysis of a perspective view of the measuring device 10 coupled to the rotating shaft 12. A key 50 shows a scale that associates a color gradation to an amount of strain (although the color is in grayscale for the images in the disclosure). As can be seen, the span 26 of the bridge 16 can experience a strain 52 during operation of the rotating shaft that can be orders of magnitude higher than a strain 54 of the collars 20a. 20b. For example, the strain 54 experienced by the collars 20a, 20b can fall largely within a range of about 5.296*10⁻⁷ to about 1.469*10⁻³, while the strain 52 experienced by the span 26 can fall largely within a range of about 5.873*10⁻³ to about 1.321*10⁻². The strain 52 on the span 26 can also be amplified as compared to a strain 56 on a surface of the shaft 12, which can be about 4.405*10⁻³. In the illustrated finite element analysis of FIG. 2, the strain 52 on the span 26 can be greater than the strain 56 on the shaft 12 by a factor of about two. Accordingly, the strain sensor 18 can be placed on the span 26 such that the strain measured by the sensor 18 can be amplified as compare to the strain 56 of the shaft 12 and the strain 54 of the connector 14. In some embodiments, the flexure zone of the bridge 16 can be significantly less stiff than the connector 14 and any portion of the bridge 16 that falls outside the flexure zone, e.g., the first abutment 24a and the second abutment 24b. In some embodiments, the flexure zone of the bridge 16 can be thin enough so as not to contribute significantly to the stiffness of the shaft 12. Advantageously, the measuring device 10 does not require a high degree of manufacturing precision to amplify a strain reading. As discussed above, the strain measured by the strain sensor 18 can be amplified as compared to the strain at a surface of the shaft 12 through a concentration of stress in the bridge 16. Amplifying the strain in this manner can reduce noise in the strain reading.

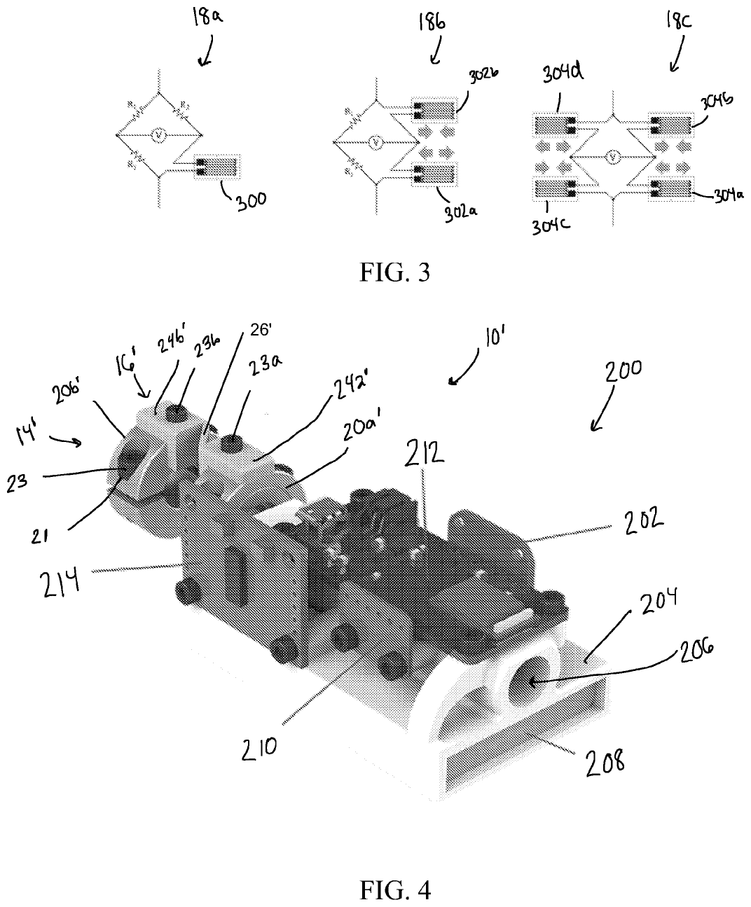

FIG. 3 shows three exemplary embodiments of the strain sensor 18. For example, the strain sensor 18 can be used in a quarter Wheatstone bridge configuration 18a, a half Wheatstone bridge configuration 18b, or a full Wheatstone bridge configuration 18c. As any of these exemplary configurations can be sufficient to measure the strain of the rotating shaft 12, as can other configurations not illustrated herein, the strain sensor 18 can be quite versatile. For example, in the measuring device 10 illustrated in FIG. 1, the quarter Wheatstone bridge configuration 18a can be sufficient to achieve a strain reading of the shaft 12. The quarter Wheatstone bridge 18a can include one strain gauge or mechanical bridge 300. For increased performance, the half Wheatstone bridge 18b can be used, which can double a strength of the strain reading as compared to the quarter Wheatstone bridge 18a. The half Wheatstone bridge 18b can include two mechanical bridges 302a, 302b that can be placed opposite one another such that when one of the two mechanical bridges is compressed while the other mechanical bridge can expand. The construction of the half Wheatstone bridge 18b can reduce noise and drift in the strain reading as changes in the two mechanical bridges 302a, 302b can cancel, or roughly cancel, each other out. The full Wheatstone bridge 18c can be used as the strain sensor 18, which can double a strength of the signal reading as compared to the half Wheatstone bridge 18b. The full Wheatstone bridge 18c can include four mechanical bridges 304a, 304b, 304c, 304d. As compared to the half Wheatstone bridge 18b, two additional bridges 304c, 304d can be mounted in a mirror-image to the two mechanical bridges 304a, 304b that can be present in the half bridge. Using a full Wheatstone bridge 18c can maximize a signal to noise ratio of the strain sensor 18.

While FIG. 3 illustrates three exemplary embodiments of the strain sensor 18 as various configurations of strain gauges, other strain gauge configurations are possible. Further, one skilled in the art will recognize that a strain gauge is one way by which strain can be measured mechanically, but other mechanisms can be employed for similar purposes, including other sensors that make mechanical measurements, as well as sensors or components that can measure strain electrically, optically, magnetically, or otherwise. Such variations can fall within the scope of the present disclosure provided the strain sensor can be mounted fully within the rotating reference plane without direct contact with the rotating shaft. By way of non-limiting example, components that measure strain using capacitive sensors can be used as the strain-measuring sensor 18. This may include two plates that move relative to each other and change capacitance, the change in capacitance being representative of the strain experienced by the rotating shaft in operation. Another alternative includes a magnetic sensor that relies on ferromagnetic properties to measure strain based on changes in a magnetic field. Still another alternative can include optical measurements.

In some embodiments, the strain sensor 18 can also be designed to detect bending of the shaft 12. A bend of the shaft 12 can cause the flexure zone of the bridge 16 to deform such that the sensor 18 can detect the deformation. The rotating shaft 12 can undergo two forms of bending. The first type of bending can result from a force applied to the shaft in a direction fixed to the stationary reference frame from an observer's point of view, which would appear to rotate in a rotating reference frame (i.e., the shaft's point of view). The sensor 18 can detect this first type of bending as a fluctuation in torque. It will cause a positive error in one orientation and a negative error in the opposite orientation. The second type of bending can result from a force on the shaft that can appear stationary in the rotating reference frame and can appear to rotate in the stationary reference frame. The sensor 18 can detect this second type of bending as a constant error in the torque reading. Effects of the second type of bending can be removed by calibrating the sensor 18 at zero torque.

If torque on the rotating shaft 12 is relatively constant within a rotation of the shaft, the bending and the torque of the shaft can be easily extracted from a strain signal measurement form the strain sensor 18. The strain signal can be averaged over a rotation of the shaft 12 to calculate an accurate torque of the shaft. Fluctuation of the strain signal in a cycle of the shaft 12 can be used to determine the bending of the shaft. Accordingly, the strain sensor 18 can be used to detect both torque and bending of the shaft 12, which can be useful in cost sensitive or volume constrained systems.

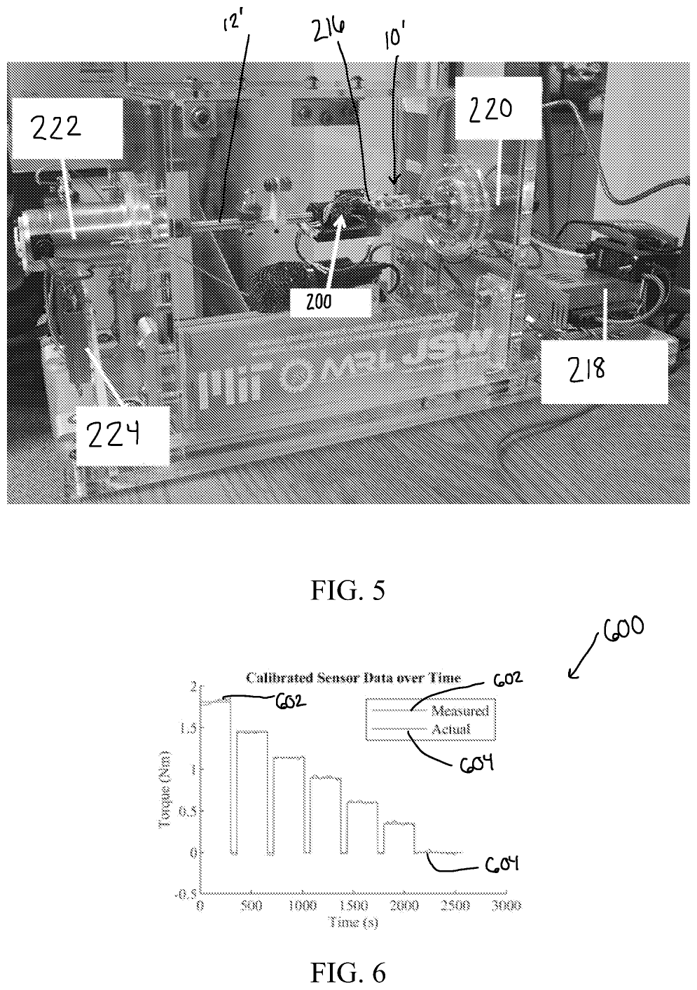

FIG. 4 illustrates another exemplary embodiment of a measuring device 10′ of the present disclosure, which can measure angular speed of a rotating shaft 12′ (FIG. 5) in a manner that does not require any component to be fixed in the stationary reference plane. The measuring device 10′ can include a connector 14′, a bridge 16′, and a strain-measuring sensor (not visible) associated with the bridge. The measuring device 10′ can include a secondary component 200 that can include, among other things, an accelerometer 202 that can detect angular speed of the rotating shaft 12′. The accelerometer 202 and, more generally, the second component 200, can rotate with the rotating shaft 12′ in the rotating reference frame.

The connector 14′ can be sized to receive the rotating shaft 12′ through a first collar 20a′ and a second collar 20b′ along a central longitudinal axis A1′ of the connector. In some embodiments, the rotating shaft 12′ can have a diameter Dₛ of about 9.5 mm and the first collar 20a′ and the second collar 20b′ can be sized accordingly. A strain sensor (not visible in FIG. 4) can be mounted a distance r_{g} of about 9 mm above a central longitudinal axis of the connector 14′, which can correspond to an axis of rotation when the shaft 12′ is received within the connector 14′. It will be appreciated that dimensions of the various components (e.g., the connector 14, 14′, collars 20a, 20b, 20a′, 20b′, the bridge 16, 16′, the shaft 12, 12′, etc.) and distances between the same can be based, at least in part, on factors such as the dimensions of other components of the device, the shaft with which the device is being used, and the desired uses and measurements, among other factors. A person skilled in the art will understand how to size the device for desired uses with a particular mechanical system. The collars 20a′, 20b′ can be machined from standard aluminum shaft collars. A flat face or surface (not visible) can be machined into a circular outer surface of each collar using, for example, a mill. A hole 21 can be drilled and tapped through each collar 20a′, 20b′ such that a bolt 23 can be inserted therethrough. In some embodiments, each collar 20a′, 20b′ can have two holes 21 for receiving a bolt, with one hole on either side of the central longitudinal axis of the connector 14′. In this manner, the collars 20a′, 20b′ can be securely coupled to the rotating shaft received therethrough by securing a bolt through each of the holes 21 in the collars. Accordingly, the connector 14′ can rotate with the rotating shaft 12.

The bridge 16′ can include a first abutment 24a′, a second abutment 24b′, and a span 26′. In some embodiments, the bridge 16′ can be made out of ABS plastic through an additive manufacturing (3D-printing) process. At least a portion of the span 26′ can form a flexure zone of the bridge 16′ that can deform when the rotating shaft 12′ is under torsional force. In some embodiments, the span 26′ can be manufactured with a thickness as small as possible with which a 3D-printer can reliably print, for example, with a thickness of about 1.5 mm. A clearance hole can be drilled through each of the first abutment 24a′ and the second abutment 24b′ such that a bolt 25a, 25b can be inserted therethrough and can secure the first and second abutments to the first and second collars 20a′, 20b′, respectively. Manufacturing of both the connector 14′ and the bridge 16′ can be done with relatively low precision as most variances can be removed by calibrating the strain sensor.

One or more strain gauges, e.g., the quarter Wheatstone bridge 18a, the half Wheatstone bridge 18b, or the full Wheatstone bridge 18c, can be glued or otherwise securely mounted to the bridge 16′ such that a strain on the flexure zone of the bridge can be measured as the flexure zone deforms with rotation of the rotating shaft. For example, the strain sensor can be associated with the span 26′.

The secondary component 200 can include a base 204 with a lumen 206 extending therethrough. The lumen 206 can be sized to receive the rotating shaft 12′ when the rotating shaft is coupled to the connector 14′. The accelerometer 202 can be mounted on the base 204. The secondary component 200 can also include a battery 206, a microphone 208, a microcontroller 210, a circuit board 212, and a load cell amplifier 214. In some embodiments, the battery 206 can be a lithium ion battery that can be used to power the measuring device 10′, as described in conjunction with FIG. 5.

FIG. 5 shows a test set-up of the measuring device 10′ with the secondary component 200 of FIG. 4 coupled to the rotating shaft 12′. Electrical connections 216 can extend between the secondary component 200 and the measuring device 10′ such that measurements from the strain sensor can be used to monitor performance of the rotating shaft 12. The set-up can also include a power source 218, a driving motor 220, a damping motor 222, and a resistor array 224. The rotating shaft 12′ can be coupled at one end to the driving motor 220 and at the other end to the damping motor 222. In some embodiments, the driving motor 220 and the damping motor 222 can be brushed DC motors and the rotating shaft 12′ can be attached to each one with a compliant coupler. The driving motor 220 can be coupled to the power supply 218, which can include an electronic speed control such that the driving motor can be controlled, for example, by a user through a computer terminal.

In some embodiments, the accelerometer 202 can be used to detect a frequency and/or amplitude of vibrations present on the shaft 12′ during operation of the shaft. This frequency data can be useful in detecting problems or abnormalities in a mechanical system associated with the rotating shaft 12′. The accelerometer 202 can measure radial acceleration of the shaft 12′ to determine the angular speed, as radial acceleration is proportional to the angular speed squared. While gravitational effects impact the readings of radial and angular acceleration in all non-vertical shafts, these effects may be insignificant relative to a centripetal acceleration of the shaft 12′ and can be averaged out if a sample rate of the accelerometer 202 is high relative to the frequency of shaft rotation (i.e., shaft rotational speed). For example, at high speeds of the shaft 12′, the centripetal acceleration is high which can minimize the gravitation effect in the signal, while at low speeds of the shaft a faster sampling rate relative to the shaft speed can be used such that gravitational effects can be averaged out.

In some instances, a frequency of the radial or angular acceleration signals measured by the accelerometer 202 can be analyzed to determine the angular speed of the shaft 12′. If the shaft 12′ is not in a vertical orientation, at least some of the signals will fluctuate in a given rotation at constant speed due to gravity on the shaft. For example, with the rotating shaft 12′ in a horizontal orientation, such as is shown in FIG. 5, and rotating at a constant angular speed, the angular acceleration of the shaft can vary from positive g to negative g with each rotation, where g is the acceleration of gravity. Similarly, the radial acceleration a_{c} of the shaft 12′ can vary from a_{c}+g to a_{c}−g. With a sufficiently high sampler rate, e.g., at least twice the angular frequency of the rotating shaft 12′, a power spectrum of the accelerometer 202 can clearly identify an angular speed of the shaft 12′ as the dominant frequency in the signal. Other frequencies in the accelerometer power spectrum can likely be the result of vibrations of the shaft 12′. Accordingly, the frequency and amplitude of such vibrations can be collected by the measuring device 10′, which can be useful information in assessing and monitoring the health of a mechanical system associated with the shaft 12′.

The damping motor 222 can be attached to the resistor array 224, which can create a simple variable viscous damper. The resistor array 224 can include relays such that resistors can be either in-line or bypassed, which can thereby create a discretely variable resistor with a resistance R. If the damping motor 222 is treated as a pure gyrator, then a torque on a motor shaft T, which can be directly coupled to the rotating shaft 12′, can be proportional to a current through the motor. A back electromagnetic field (EMF) from the damping motor 222 can be proportional to an angular speed of the motor shaft ω. This proportionality constant can be the motor torque constant, Kₜ. Combining these with Kirchhoff's Voltage Law, torque and speed can follow the relation shown in Equation (4). This relation between torque and speed is the same as that of a rotary damper with a damping coefficient of Kₜ²/R. This device is much easier to vary that a fluid-based damper. An encoder can be added to one or both of the motor shaft T and the rotating shaft 12′ to verify the angular speed as measured by the accelerometer 202.

$$T = \frac{{K}_{t}^{2}}{R} ω \qquad ( 4 )$$

With continued reference to FIGS. 4 and 5, the electrical connections 216 can connect the strain senor, e.g., the quarter Wheatstone bridge 18a, the half Wheatstone bridge 18b, or the full Wheatstone bridge 18c, of the measuring device 10′ to the load cell amplifier 214 of the secondary component 200. For example, the load cell amplifier 214 can be an HX711 Load Cell Amplifier chip that can include a voltage regulator, amplifier, and analog to digital converter (ADC), and can be designed for load cells in the Wheatstone bridge configuration. In the test set-up of FIG. 5, the load cell amplifier 216 can have a maximum sampling of about 80 Hz, a 24-bit resolution, and a maximum voltage difference of about ±0.5 Volts. The strain sensor can be the full Wheatstone bridge 18c, which can include four 350Ω strain gauges, i.e., the mechanical bridges 304a, 304b, 304c, 304d, with a gauge factor of 2. The power source 218 can provide a 3.3V supply voltage to the strain sensor which, with the load cell amplified 214, can result in a maximum detectable strain of about 7.2%. In some instances, a strain gauge of the Wheatstone bridge 18a, 18b, 18c can have a maximum strain of about 2%, and can therefore be the limiting factor in the maximum torque that the strain sensor can detect.

The measuring device 10′ can be constructed such that saturation of the strain sensor can be prevented. For a rotating shaft with a maximum shear stress τₘₐₓ and a strain gauge with maximum strain ϵ_{g,max}, the shaft will break before the sensor is saturated if the condition in Equation (5) is met, where Dₛ is the diameter of the rotating shaft, G is the shear modulus of the shaft material, and r_{g} is the distance from a rotation axis of the shaft to the strain sensor.

$${τ}_{max} < \frac{{D}_{s} G}{{r}_{q}} {𝔈}_{g , max} \qquad ( 5 )$$

For example, in one embodiment a strain sensor can be placed a distance of about 5 mm above a surface of a rotating shaft. This distance can be a practical and achievable distance in most mechanical systems. In other words, the distance r_{g} of the strain sensor from a central longitudinal axis of the rotating shaft, i.e., the axis of rotation, can be equal to half of the shaft diameter plus about 5 mm. With such a construction the strain sensor will not typically saturate so long as the shaft diameter is larger than about 1.5 mm for steel and about 2.3 mm for aluminum.

Data from the amplifier load cell 214 and the accelerometer 202 can be transferred to the microcontroller 212. In some embodiments, the microcontroller 212 can transmit the data, for example, via Wi-Fi, to a computing console such that the data can be read by a user. The microcontroller 212 can conserve power in the data transmission process. For example, the microcontroller 212 can sample data at a high sample rate, can pause data sampling for at least a portion of a duration of data transmission, and can resume sampling following data transmission. The sample rate and a sampling pause time can be programmed to adapt to operating conditions, constraints, and/or requirements of a particular mechanical system and rotating shaft.

Experimental Results

Experimental results obtained from the measuring device 10′ and secondary component 200 of the set-up of FIG. 5 are described with reference to FIGS. 6-10. In a first experimental set-up, the rotating shaft 12′ was restricted from rotating by fixing one end of the shaft. This can remove complications that can arise from continuous rotation, such as centripetal acceleration and movement of the electrical connections 216, and can also present a much simpler configuration for exerting a constant known torque on the shaft. Accordingly, the measuring device 10′ and secondary components 200 can be more rapidly and accurately calibrated for testing purposes with the shaft 12′ fixed at one end. In one experiment, the results of which are illustrated in FIG. 6, a known weight was applied to a lever arm, which can induce a known torque on the measuring device 10′ and, more particularly, the strain sensor. The weight applied to the lever arm can be varied to vary the induced torque. FIG. 6 illustrates experimental results of calibrating the measuring device 10′ in a graph 600 showing torque applied to the shaft 12′ over time. More particularly, the graph 600 plots a torque 602 on the shaft 12′ as measured by the measuring device 10′ and an actual torque 604 applied to the shaft. The graph of FIG. 6 illustrates that the deformation and respective strain readings of the sensor can be linear with the applied torque 604. Additionally, the graph 600 evidences that the measuring device 10′ can hold calibration at least for time scales of about half-an-hour.

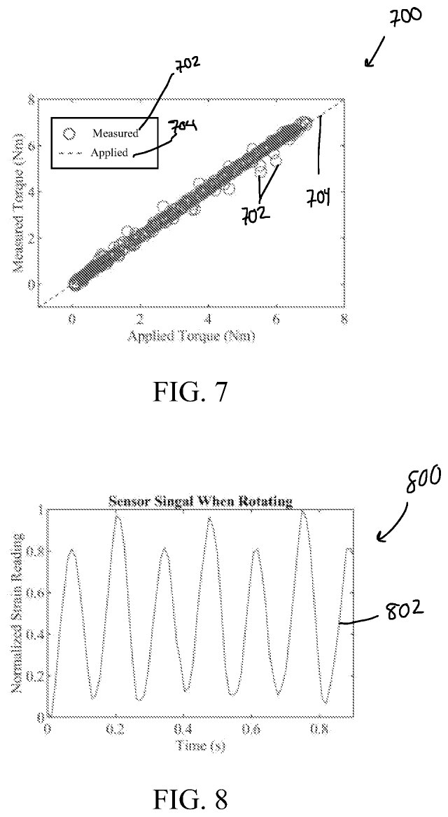

Another test of the measuring device 10′ of FIG. 5 was conducted with a lever arm of a known length l and a calibrated force meter that can measure an applied force F so that an applied torque can be continually varied and measured. FIG. 7 shows a graph 700 plotting a resulting torque 702 (Tₛ) as measured by the measuring device 10′ against an applied torque 704. Equation (6) can be used to calculate a sample error δ. From analyzing the sample error, it can be found that in over 70% of samples, the measuring device 10′ had less that a 0.4% error. There was no experimental sample that had more than a 1.6% error.

$$δ = \frac{\vert {T}_{s} - Fl \vert}{F l} \qquad ( 6 )$$

The measuring device 10′ can be designed to measure bending and torque of the rotating shaft 12′ during operation, i.e., rotation, of the shaft. In instances in which the applied torque can be relatively constant within a rotation of the shaft 12′ and all bending of the shaft 12′ is in a fixed direction so that the bending appears as rotating from the perspective of the shaft, both the torque and the bending can be derived from the measuring device 10′ in a relatively simple manner. As can be seen from the graph of FIG. 7, the torque 702 measured by the measuring device 10′ can closely match the actual applied torque 704. In some instances, such as the experimental set-up of FIG. 5, bending of the shaft 12′ can result from a weight of the measuring device 10′. Gravity can constantly exert a pull the measuring device 10′, which can cause the shaft 12′ to bend. As the size of the shaft 12′ increases, the bending of the shaft due to gravitational forces on the measuring device 10′ can decrease. In most practical applications, the weight of the measuring device 10′ as compared to the shaft 12′ would be insignificant, thereby rendering bending of the shaft due to gravitational effects of the measuring device insignificant.

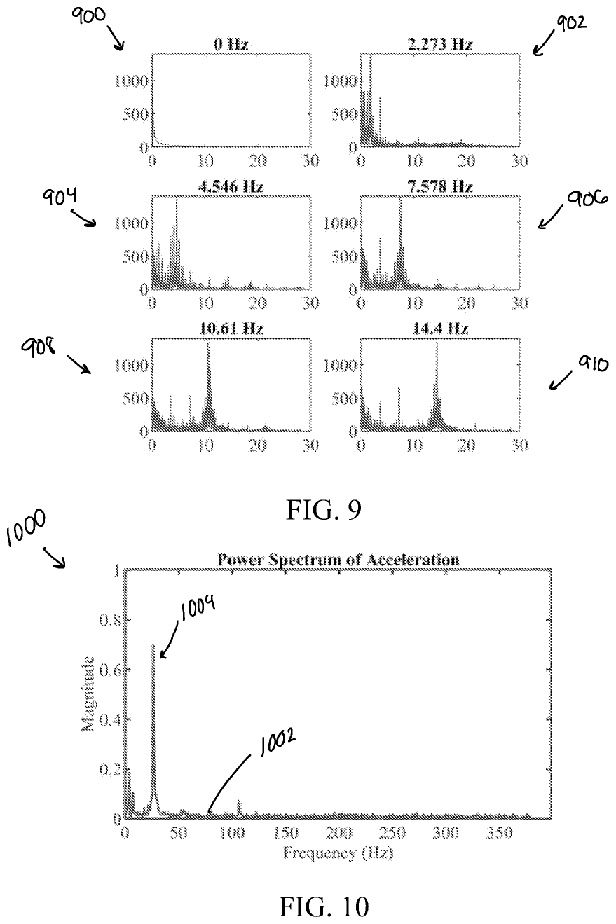

FIG. 8 is a graph 800 plotting a strain reading 802 output from the strain sensor and, more broadly, the measuring device 10′ over time during rotation of the rotating shaft 12′. The strain reading 802 can approximate a sine wave, with a mean of the signal proportional to a torque and an amplitude bending of the shaft 12′. The strain reading 802 of FIG. 8 was taken with the rotating shaft 12′ spinning at about 7.6 Hertz (Hz) with a data sampling of about 57 Hz. The dominant frequency in the strain reading, i.e., a signal from the strain sensor 18, can be the speed of the rotating shaft 12′. FIG. 9 illustrates this with six plots 900, 902, 904, 906, 908, 910 that plot a power spectrum of the strain sensor signal at shaft speeds of 0 Hz, approximately 2.273 Hz, approximately 4.546 Hz, approximately 7.578 Hz, approximately 10.61 Hz, and approximately 14.4 Hz, respectively. Some noise can be seen in at least some of the plots of FIG. 9 that can occur while spinning.

Based on testing performed with the experimental set-up of FIG. 5, acceleration of the rotating shaft 12′ can be successfully determined using the frequency method. FIG. 10 is a graph 1000 that plots a magnitude 1002 of a power spectrum of angular acceleration as a function of frequency over one second of the angular acceleration data. A peak 1004 in the magnitude 1002 of the power spectrum can be seen at about 26.5 Hz, which can identify the speed of the rotating shaft 12′.

Further Discussion of Disclosed Devices and Methods

One advantage of the measuring devices 10, 10′ disclosed herein can be the low cost at which a digital signal of torque of the rotating shaft 12, 12′ can be obtained. For example, in some embodiments, the measuring device 10, 10′ can cost less than about USD$13.00. With bulk manufacturing, the cost can be reduced even further. Accordingly, the measuring devices disclosed herein can serve as a cost-effective solution to assessing, monitoring, and/or controlling the health of a mechanical system with a rotating shaft.

Examples of the above-described embodiments can include the following:
1. A device for monitoring a mechanical system that includes a rotating shaft, the device comprising:
   a connector configured to couple to a rotating shaft, the connector having a first reference location and a second reference location;
   a bridge coupled to the connector and extending between the first reference location and the second reference location, the bridge being configured to be disposed such that a longitudinal axis thereof is laterally offset from a central longitudinal axis of the rotating shaft when the connector is coupled to a rotating shaft, the longitudinal axis and the central longitudinal axis being substantially parallel to each other, and the bridge including a flexure zone configured to deform in response to the rotating shaft undergoing a torsional force during operation of the rotating shaft; and
   a strain-measuring sensor associated with the bridge, disposed between the first reference location and the second reference location, the sensor being configured to determine a magnitude of the torsional force experienced by the rotating shaft during operation of the rotating shaft based on a strain measured by the strain-measuring sensor.
2. The device of claim 1, wherein each of the connector, the bridge, and the strain-measuring sensor are configured to rotate with the rotating shaft such that strain is measured by the strain-measuring sensor without a stationary reference frame.
3. The device of claim 1 or claim 2, wherein the strain-measuring sensor is further configured to detect bending of the rotating shaft during operation of the rotating shaft.
4. The device of any one of claims 1 to 3, further comprising an accelerometer configured to determine a rotational speed of the rotating shaft during operation of the rotating shaft.
5. The device of claim 4, wherein the accelerometer is further configured to detect at least one of a frequency of vibrations present on the rotating shaft during operation of the rotating shaft and an amplitude of vibrations present on the rotating shaft during operation of the rotating shaft.
6. The device of any one of claims 1 to 5, wherein the strain-measuring sensor comprises two mechanical bridges disposed in a half Wheatstone bridge configuration.
7. The device of any one of claims 1 to 5, wherein the strain-measuring sensor comprises four mechanical bridges disposed in a full Wheatstone bridge configuration.
8. The device of any one of claims 1 to 7, wherein the bridge further comprises:
   a first abutment coupled to the connector more proximate to the first reference location than the second reference location;
   a second abutment coupled to the connector more proximate to the second reference location than the first reference location; and
   a span extending between the first abutment and the second abutment, the strain-measuring sensor being associated with the span.
9. The device of claim 8, wherein the connector further comprises:
   a first collar that includes the first reference location, the first abutment being coupled to the first collar; and
   a second collar that includes the second reference location, the second abutment being coupled to the second collar.
10. The device of any one of claims 1 to 9, wherein the strain-measuring sensor is configured to measure strain in tension.
11. The device of any one of claims 1 to 10, wherein the strain-measuring sensor comprises a tensile strain gauge.
12. The device of any one of claims 1 to 11, wherein the strain measured by the strain-measuring sensor is greater than a strain experienced by the rotating shaft when it is undergoing the torsional force.
13. The device of claim 12, wherein the bridge is configured such that a distance of the lateral offset between the longitudinal axis of the bridge and the central longitudinal axis of the rotating shaft is adjustable to in turn adjust the difference between the strain measured by the strain-measuring sensor and the strain experienced by the rotating shaft when it is undergoing the torsional force.
14. The device of any one of claims 1 to 13, wherein the bridge has a modulus of rigidity that is at least five times less than a modulus of rigidity of the rotating shaft.
15. A method for monitoring a mechanical system that includes a rotating shaft, the method comprising:
   measuring a mechanically amplified strain of a rotating shaft of a mechanical system using a strain-measuring device coupled to the rotating shaft of the mechanical system such that the strain-measuring device rotates with the rotating shaft when the rotating shaft is being operated, the measured mechanically amplified strain being greater than a strain experienced by the rotating shaft when it is being operated.
16. The method of claim 15, wherein each and every component of the strain-measuring device configured to be coupled to the rotating shaft or measure a strain associated with the rotating shaft rotates with the rotating shaft when the rotating shaft is being operated.
17. The method of claim 16, wherein each and every component of the strain-measuring device configured to be coupled to the rotating shaft or measure a strain associated with the rotating shaft comprises:
   a connector coupled to the rotating shaft;
   a bridge coupled to the connector; and
   a strain-measuring sensor associated with the bridge, the sensor performing the action of measuring the mechanically amplified strain of the rotating shaft.
18. The method of claim 17, wherein the bridge is disposed such that a longitudinal axis thereof is laterally offset from a central longitudinal axis of the rotating shaft, the longitudinal axis and the central longitudinal axis being substantially parallel to each other.
19. The method of any one of claims 15 to 18, further comprising:
   coupling the strain-measuring device to the rotating shaft.
20. The method of claim 19, wherein coupling the strain-measuring device to the rotating shaft further comprises:
   coupling a first collar of the strain-measuring device to a first location on the rotating shaft; and
   coupling a second collar of the strain-measuring device to a second location on the rotating shaft, the strain-measuring device further comprising a bridge extending between the two collars, and a longitudinal axis of the bridge being laterally offset from a central longitudinal axis of the rotating shaft, the longitudinal axis and the central longitudinal axis being substantially parallel to each other.
21. The method of claim 20, further comprising:
   adjusting a distance of the lateral offset between the longitudinal axis of the bridge and the central longitudinal axis of the rotating shaft to adjust a value of the mechanically amplified strain with respect to the strain experienced by the rotating shaft when it is being operated.
22. The method of any one of claims 15 to 21, wherein the strain-measuring device comprises a strain-measuring sensor, the strain-measuring sensor being disposed a distance away from the rotating shaft such the strain-measuring sensor does not directly contact the rotating shaft and is laterally offset from a central longitudinal axis of the rotating shaft.
23. The method of any one of claims 15 to 22, further comprising:
   detecting bending of the rotating shaft during operation of the rotating shaft using the strain-measuring device.
24. The method of any one of claims 15 to 23, further comprising:
   determining a rotational speed of the rotating shaft during operation of the rotating shaft using the strain-measuring device.
25. The method of claim 24, further comprising:
   detecting at least one of a frequency of vibrations present on the rotating shaft during operation of the rotating shaft and an amplitude of vibrations present on the rotating shaft during operation of the rotating shaft using the strain-measuring device.
26. The method of claim 25, further comprising:
   detecting bending of the rotating shaft during operation of the rotating shaft using the strain-measuring device.
27. The method of any one of claims 15 to 26, wherein the strain-measuring device measures the mechanically amplified strain of the rotating shaft of the mechanical system in tension.

1. A device for monitoring a mechanical system that includes a rotating shaft, the device comprising:
a connector configured to couple to a rotating shaft, the connector having a first reference location and a second reference location;
a bridge coupled to the connector and extending between the first reference location and the second reference location, the bridge being configured to be disposed such that a longitudinal axis thereof is laterally offset from a central longitudinal axis of the rotating shaft when the connector is coupled to a rotating shaft, the longitudinal axis and the central longitudinal axis being substantially parallel to each other, and the bridge including a flexure zone configured to deform in response to the rotating shaft undergoing a torsional force during operation of the rotating shaft; and
a strain-measuring sensor associated with the bridge, disposed between the first reference location and the second reference location, the sensor being configured to determine a magnitude of the torsional force experienced by the rotating shaft during operation of the rotating shaft based on a strain measured by the strain-measuring sensor.

2. The device of claim 1, wherein each of the connector, the bridge, and the strain-measuring sensor are configured to rotate with the rotating shaft such that strain is measured by the strain-measuring sensor without a stationary reference frame.

3. The device of claim 1, wherein the strain-measuring sensor is further configured to detect bending of the rotating shaft during operation of the rotating shaft.

4. The device of claim 1, further comprising an accelerometer configured to determine a rotational speed of the rotating shaft during operation of the rotating shaft.

5. The device of claim 4, wherein the accelerometer is further configured to detect at least one of a frequency of vibrations present on the rotating shaft during operation of the rotating shaft and an amplitude of vibrations present on the rotating shaft during operation of the rotating shaft.

6. (canceled)

7. (canceled)

8. The device of claim 1, wherein the bridge further comprises:
a first abutment coupled to the connector more proximate to the first reference location than the second reference location;
a second abutment coupled to the connector more proximate to the second reference location than the first reference location; and
a span extending between the first abutment and the second abutment, the strain-measuring sensor being associated with the span.

9. The device of claim 8, wherein the connector further comprises:
a first collar that includes the first reference location, the first abutment being coupled to the first collar; and
a second collar that includes the second reference location, the second abutment being coupled to the second collar.

10. The device of claim 1, wherein the strain-measuring sensor is configured to measure strain in tension.

11. (canceled)

12. (canceled)

13. The device of claim 12, wherein the bridge is configured such that a distance of the lateral offset between the longitudinal axis of the bridge and the central longitudinal axis of the rotating shaft is adjustable to in turn adjust the difference between the strain measured by the strain-measuring sensor and the strain experienced by the rotating shaft when it is undergoing the torsional force.

14. (canceled)

15. A method for monitoring a mechanical system that includes a rotating shaft, the method comprising:
measuring a mechanically amplified strain of a rotating shaft of a mechanical system using a strain-measuring device coupled to the rotating shaft of the mechanical system such that the strain-measuring device rotates with the rotating shaft when the rotating shaft is being operated, the measured mechanically amplified strain being greater than a strain experienced by the rotating shaft when it is being operated.

16. The method of claim 15, wherein each and every component of the strain-measuring device configured to be coupled to the rotating shaft or measure a strain associated with the rotating shaft rotates with the rotating shaft when the rotating shaft is being operated.

17. The method of claim 16, wherein each and every component of the strain-measuring device configured to be coupled to the rotating shaft or measure a strain associated with the rotating shaft comprises:
a connector coupled to the rotating shaft;
a bridge coupled to the connector; and
a strain-measuring sensor associated with the bridge, the sensor performing the action of measuring the mechanically amplified strain of the rotating shaft.

18. The method of claim 17, wherein the bridge is disposed such that a longitudinal axis thereof is laterally offset from a central longitudinal axis of the rotating shaft, the longitudinal axis and the central longitudinal axis being substantially parallel to each other.

19. The method of claim 15, further comprising:
coupling the strain-measuring device to the rotating shaft.

20. The method of claim 19, wherein coupling the strain-measuring device to the rotating shaft further comprises:
coupling a first collar of the strain-measuring device to a first location on the rotating shaft; and
coupling a second collar of the strain-measuring device to a second location on the rotating shaft, the strain-measuring device further comprising a bridge extending between the two collars, and a longitudinal axis of the bridge being laterally offset from a central longitudinal axis of the rotating shaft, the longitudinal axis and the central longitudinal axis being substantially parallel to each other.

21. The method of claim 20, further comprising:
adjusting a distance of the lateral offset between the longitudinal axis of the bridge and the central longitudinal axis of the rotating shaft to adjust a value of the mechanically amplified strain with respect to the strain experienced by the rotating shaft when it is being operated.

22. (canceled)

23. The method of claim 15, further comprising:
detecting bending of the rotating shaft during operation of the rotating shaft using the strain-measuring device.

24. The method of claim 15, further comprising:
determining a rotational speed of the rotating shaft during operation of the rotating shaft using the strain-measuring device.

25. The method of claim 24, further comprising:
detecting at least one of a frequency of vibrations present on the rotating shaft during operation of the rotating shaft and an amplitude of vibrations present on the rotating shaft during operation of the rotating shaft using the strain-measuring device.

26. The method of claim 25, further comprising:
detecting bending of the rotating shaft during operation of the rotating shaft using the strain-measuring device.

27. (canceled)
